(19) United States
(12) Patent Application Publication
(10) Pub. No.: US 2013/0206599 A1
(43) Pub. Date: Aug. 15, 2013

(54) METHOD FOR MEASURING THE URANIUM CONCENTRATION OF AN AQUEOUS SOLUTION BY SPECTROPHOTOMETRY

(71) Applicant: Magali Celier, Le Palais Sur Vienne (FR)

(72) Inventor: Magali Celier, Le Palais Sur Vienne (FR)

(73) Assignee: AREVA NC, Paris (FR)

(21) Appl. No.: 13/824,339

(22) PCT Filed: Sep. 13, 2011
(86) PCT No.: PCT/EP2011/065806

§ 371 Date: Apr. 17, 2013

(30) Foreign Application Priority Data
Sep. 16, 2010 (FR) 1057407

(51) Int. Cl. G01J 3/02

(52) U.S. Cl. CPC G01J 3/0297
USPC 205/46

(57) ABSTRACT

A method for measuring the uranium concentration of an aqueous solution including the following successive steps: a) electrochemical reduction towards valence IV, of the uranium present in the aqueous solution with a valence greater than IV, this reduction being implemented at pH<2 and by passing an electrical current in the solution; b) measurement of the absorbance of the solution obtained on completion of step a) at a chosen wavelength between 640 and 660 nm, and preferably 652 nm; and c) determination of the uranium concentration of the aqueous solution by deduction of the uranium concentration of valence (IV) present in the aqueous solution obtained on completion of step a) from measurement of the absorbance obtained in step b).

### TECHNICAL FIELD

The invention relates to a method allowing the dosage of uranium present in an aqueous solution.

This method is applicable in particular to the dosage of uranium present in aqueous solutions for production of uranium-bearing concentrates, in aqueous solutions for treatment of irradiated nuclear fuel, in effluents containing uranium deriving from mining production sites or uranium treatment plants and, generally, in all types of aqueous solution containing uranium, notably in the nuclear fuel cycle field.

### STATE OF THE PRIOR ART

Among the known techniques for the dosage of uranium in liquid media, only spectrophotometry enables conclusive results to be obtained in an industrial, constrictive context, and in particular in an on-site and non-laboratory analysis.

The dosage of uranium in a liquid medium by spectrophotometry is currently obtained by producing a complex with uranium, and in then detecting the absorbance of this complex, and by this means deducing its concentration by applying the Beer-Lambert law. On this subject, the technique known by the name of “Bromo-PADAP method” may be mentioned. This method consists in forming a coloured complex of uranyl-bromo-PADAP in a propanol medium, followed by spectrophotometry at a wavelength of 574 nm, which is equal to the maximum absorption wavelength of the complex.

The disadvantage of these techniques of measurement by spectrophotometry of a uranium complex is that they are particularly sensitive to the presence of certain anions and/or cations in the solution, which causes interferences with measurement of the absorbance of the complex, and can therefore distort this measurement. In addition, they make use of additional chemical reactions requiring the addition of a reagent.

As an example, the technique of the “Bromo-PADAP method” mentioned above is particularly sensitive to iron cations, which distort measurements of the absorbance of the uranyl-bromo-PADAP complex if they are present in the solution at a concentration of greater than or equal to 40 mg/L. However, ions, and notably iron cations, are very often present in non-negligible quantities (i.e. greater than 100 mg/L) in solutions containing uranium, such as effluents derived from uranium treatment processes.

The inventors therefore set themselves the aim of designing a method for measuring the uranium concentration of an aqueous solution which did not have the disadvantages of the prior art or, at the very least, which was less sensitive to the presence of ions in the solution, and which would not involve the addition of additional chemical reagents.

### DESCRIPTION OF THE INVENTION

This goal is attained by virtue of a method for measuring the uranium concentration of an aqueous solution including the following successive steps:

a) electrochemical reduction towards valence IV, of the uranium present in the aqueous solution with a valence greater than IV, this reduction being implemented at pH<2 and by passing an electrical current in the solution;

b) measurement of absorbance of the solution obtained on completion of step a) at a chosen wavelength between 640 and 660 nm; and

c) determination of the uranium concentration of the aqueous solution by deduction of the uranium concentration of valence (IV) present in the aqueous solution obtained on completion of step a) from measurement of the absorbance obtained in step b).

If the pH of the aqueous solution is initially greater than or equal to 2, the pH of the solution is reduced by adding a concentrated acid to it until a pH<2 is obtained, for example by using sulphuric acid.

It is stipulated that the pH value of the aqueous solution as given in this description is a pH value measured under standard temperature and pressure conditions, which are well known to the skilled man in the art.

From the absorbance value obtained in step b) the solution's uranium concentration is deduced by determination of the concentration of uranium of valence IV present in the solution obtained on completion of step a) by application of the Beer-Lambert law. Indeed, in accordance with Beer-Lambert law, absorbance is proportional to the concentration of analyte present in a solution, and to the length of the optical path in this solution.

The electrochemical reduction of the uranium present in the aqueous solution is advantageously implemented by undertaking the following successive steps:

distribution of the pH<2 solution in a first and second compartment of an electrochemical cell, where each compartment includes an electrode intended to be in contact with the solution contained in this compartment, and where the first and second compartments are separated from one another by a means allowing only electrons to pass from one compartment to the other;

application of an electrical current between the two electrodes to trigger an oxidation-reduction reaction, where the uranium of the fraction of solution contained in one of the compartments undergoes reduction, whereas the other fraction of solution contained in the other compartment undergoes oxidation.

It is stipulated that the means allowing the passage of electrons does not permit the fractions of solutions present in their respective compartments to be mixed with one another.

The means allowing the passage of electrons is preferably a sintered material, for example sintered glass. It may for example be a wall made of sintered glass.

Step b) of measurement of absorbance of the solution obtained on completion of step a) is advantageously implemented by undertaking the following successive steps:

injection of all or part of the solution obtained on completion of step a) in at least one measuring cell, the interior of which forms an optical path greater than or equal to 5 centimetres between a first and a second end of the said measuring cell;

transmission of a light beam of chosen wavelength through the said at least one measuring cell, where the light beam enters by the first end and exits by the second end of the measuring cell;

detection of this light beam at its exit from the measuring cell by the second end.

It is stipulated that the solution obtained on completion of step a) is the fraction of solution having undergone a reduction reaction, i.e. the fraction of solution present in the compartment in which the reduction reaction has taken place.

The measuring cell exists in different forms. In the case of small useful volumes, there are circulation tanks or long and extended optical paths of 1 to 10 cm and capillaries of 10 cm to 5 m. The choice is made in accordance with the desired quantification limit and the type of matrix to be analysed.

The measuring cells advantageously are two in number, and have optical paths of different lengths, in order to extend the dynamic measuring range.

By having two (or more) measuring cells having optical paths of different lengths, it is possible to choose to make the absorbance measurement with a measuring cell having a small optical path for high concentrations, and to use a measuring cell having a longer optical path to measure smaller concentrations. By this means the detection limits of the spectrophotometer can be reduced. Indeed, the longer the optical path the lower the detection limit. By using a measuring cell with an optical path of 5 cm, and a measuring cell with an optical path of 2 metres, uranium concentrations of between 1 and 1500 mg/L can be measured.

The chosen wavelength is advantageously the wavelength for which the absorbance of uranium (IV) is the greatest. Furthermore, the advantage of the chosen wavelength is that it has fewer interferences with the metal cations present in the solution. This wavelength is 652 nm.

The method according to the invention preferably also includes a step of cleaning of the first and second compartments of the electrochemical cell, where this step is implemented by injection of diluted acid (for example a 1% diluted acid) in each of the compartments, and application of a current between the electrodes, where this current is applied in an opposite direction to the current applied to implement the reduction of the uranium in step a). The current is in fact applied so as to obtain an oxidation reaction in the compartment where a reduction reaction occurred.

The method preferably also includes a step of cleaning of the said at least one measuring cell, where this step is implemented after the step of detection of the light beam, and is obtained by injection of a 1% diluted acid into the said at least one measuring cell.

The aqueous solution is advantageously chosen from among the solutions for production of uranium-bearing concentrates, the effluents produced in the course of treatment of a uranium-bearing ore, or the effluents produced in the course of treatment of an irradiated nuclear fuel.

The measuring method described above has the advantage that there is no requirement to use reagents or additional chemical steps. Indeed, unlike the measuring methods known from the prior art, the method according to the invention uses no reagents, i.e. no substances intended to react or interact with the uranium.

This measuring method also enables the uranium concentration of an aqueous solution to be known for a concentration of between 1 and 1500 mg/L.

The method according to the invention also has the advantage that it can be automated.

The invention thus also relates to a method for inline measurement of the uranium concentration of an aqueous solution including the following successive steps:

i) sampling of a volume of aqueous solution;

ii) measurement of the uranium concentration of this volume of aqueous solution by the measuring method as described above;

iii) repetition of steps i) and ii) (n−1) times to obtain n measurements of the uranium concentration of the aqueous solution, where n is an integer greater than or equal to 2.

It is recalled that an inline measurement is an in situ and automated measuring method.

The n measurements can be made at time intervals which may or may not be regular. The measurements can also be made continuously.

Both methods according to the invention (the measurement method and the inline measurement method) can be used in mining production sites, for analysis of the water derived from the treatment methods and from effluents.

The inline measurement method in particular enables online monitoring of low-concentration uranium flows, notably for the technique of ISR (In Situ Recovery), monitoring of uranium concentration, etc.

### BRIEF DESCRIPTION OF THE DRAWINGS

The invention will be better understood and other advantages and features will appear on reading the following description, which is given as a non-restrictive example, accompanied by the appended figures, among which:

FIG. 1 represents a front schematic section view of an electrochemical cell with two compartments;

FIG. 2 contains various absorbance spectra as a function of the wavelength obtained according to the method of the invention, using a measuring cell having an optical path of 5 cm for different concentrations (calibration);

FIG. 3 contains various absorbance spectra as a function of the wavelength obtained according to the method of the invention, using a measuring cell having an optical path of 10 cm for different concentrations (calibration);

FIG. 4 represents a calibration curve obtained from the spectra of FIG. 2;

FIG. 5 represents a calibration curve obtained from the spectra of FIG. 3;

FIG. 6 is a schematic diagram of the inline analysis according to the invention.

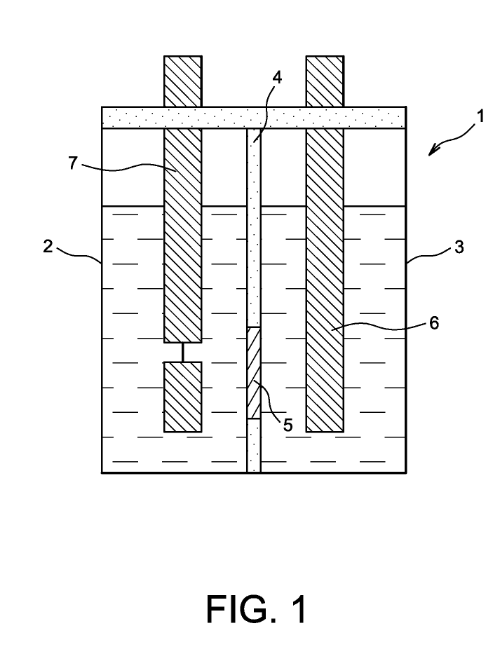

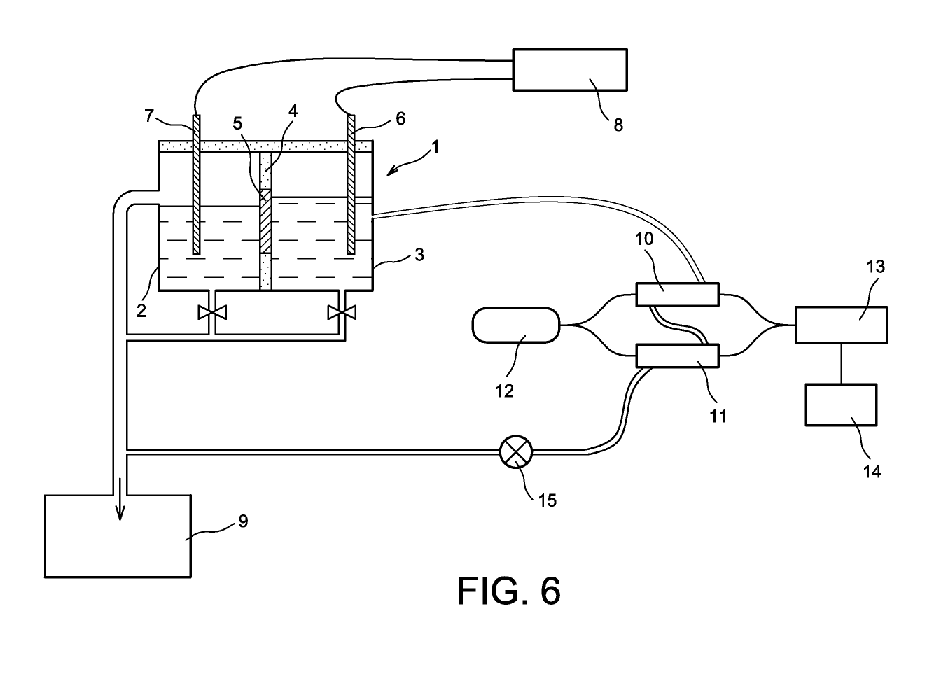

It should be noted that the different elements in FIGS. 1 and 6 are not drawn on scale.

### DETAILED DESCRIPTION OF PARTICULAR EMBODIMENTS

The measuring method according to the invention includes a first step of electrochemical reduction of the uranium contained in the aqueous solution for analysis, followed by a second step of spectrophotometric analysis of the solution obtained on completion of step a) by measurement of its absorbance.

The method according to the invention is, indeed, based on analysis of uranium at its valence IV (reduced form) at the wavelength for which absorbance of uranium (IV) is the greatest. An electrochemical reduction is therefore undertaken in order for the uranium present in the aqueous solution to change from a state of valence VI to a state of valence IV. After this, a spectrophotometric measurement is undertaken at 652 nm, which equals to the maximum absorbance of uranium of valence IV.

In fact, if the reduction is undertaken during a sufficient period, all or almost all the uranium present in the solution is found in its reduced form, i.e. in a state of oxidation IV. By measuring absorbance at 652 nm, the concentration of uranium (IV) is reached which, due to the electrochemical reduction, is also equivalent to the concentration of all the uranium present in the solution.

An additional advantage of the method according to the invention is that few elements absorb at 652 nm: by undertaking a spectrophotometric analysis at 652 nm the wavelength of uranium is more sensitive and is subject to less interference, which therefore to a certain extent enables the impact of the interferences due to the metal cations on the measurement of the absorbance to be reduced appreciably.

We shall now describe in detail how the reduction step and the spectrophotometry step are implemented.

Reduction Step:

To undertake the reduction the following are used:

an electrochemical cell with two compartments, which is dimensioned according to the useful volume for the analysis;

an auxiliary electrode: a platinum electrode;

a working electrode: an electrode made of sintered carbon;

a potentiostat able to reach 1 Ampere;

a software and a computer enabling the potentiostat to be controlled.

As illustrated in FIG. 1, the electrochemical cell, 1 which is used to implemente the reduction, is a conventional two compartments cell. In this representation, the two compartments 2, 3 are obtained by placing a separating wall 4 between two opposite walls of an enclosure. To allow electrons to pass from the solution of one compartment to the other, whilst preventing the solutions present in the two compartments from mixing, at least a portion 5 of separating wall 4 is porous. This porous portion 5 is made from a sintered material, for example sintered glass.

Working electrode 6 is positioned in one of the compartments (this compartment is rightly called the “working compartment”), while auxiliary electrode 7 is positioned in the other compartment.

The aqueous solution to be dosed is introduced into the electrochemical cell and distributed between the two compartments of this cell.

It is important that the aqueous solution has a pH of less than 2 (this is a requisite condition for satisfactory proton reduction of uranium). Consequently, before initiating the oxidation-reduction reaction a check is made that the pH of the solution is indeed less than 2, and if this is not the case the solution is acidified, for example by pouring concentrated sulphuric acid into it.

When a current is applied between the electrodes using the potentiostat, an oxidation occurs in the compartment containing the auxiliary electrode, whilst a reduction occurs in the compartment containing the working electrode.

In order for the measurement of uranium (IV) concentration to reflect accurately the uranium concentration in the aqueous solution to be dosed, it is important that the uranium is reduced completely. It is therefore important that the current between the electrodes is stopped only when the reduction of the uranium is complete. It is therefore necessary to determine the minimum time required for complete reduction of the uranium of valence VI contained in the volume of the working compartment. To this end, tests are undertaken beforehand using the aqueous solution containing the highest uranium content among the solutions to be dosed. As an indication, 20 minutes with a current of 1 Ampere are sufficient to reduce a volume of 3.5 mL of solution having a 1500 mg/L uranium content.

When all the uranium has been reduced the solution having undergone the reduction is recovered, and conveyed towards the spectrophotometric analysis portion. As for the solution having undergone oxidation, it is also removed from its compartment, but it is not used. It can, for example, be evacuated into a waste container. The solution having undergone the reduction can be conveyed using a PTFE (Teflon®) suction capillary, positioned at a sufficient height from the base that it does not draw up any deposits, in the compartment containing the reduced uranium, which will convey the solution containing uranium (IV) to the spectrophotometer measuring cell by means, for example, of a peristaltic pump.

When drained, the compartments of the cell are preferably cleaned, for example by being filled with 1% diluted acid, and by applying a current at the electrodes in a reverse direction to the current applied to implement the reduction, such that an oxidation reaction occurs in the compartment where a reduction reaction occurred, and a reduction reaction occurs in the other compartment. The oxidation will enable any metal deposit which may be present at the base of the compartment, and possibly on the electrode, to be returned to solution, in the form of cations. The cleaning solution is then removed from the compartments.

Once cleaned, the compartments of the electrochemical cell are operational once again, and can be reused to undertake a reduction of a new sample of aqueous solution.

It should be noted that it is important to analyse the rinsing time required between two samples, particularly if it is desired to implement automatic measurements, and measurements at regular uranium dosage intervals.

It should also be noted that, in addition to the auxiliary electrode and the working electrode, the electrochemical cell can also contain a reference electrode, the role of which will be to control the reaction more precisely (monitoring of potential), as represented in FIG. 1 by the excrescence positioned at the end of electrode 7.

Step of Measurement of Absorbance by Spectrophotometry:

The dosage of the solution will be implemented by using a spectrophotometer.

To undertake the dosage we therefore require the following elements:

a spectrophotometer enabling an analysis at 652 nm to be implemented; the light source of the spectrophotometer may, for example, be a halogen lamp;

at least one measuring cell intended to receive a sample of the solution to be measured, this measuring cell having an optical path suitable for the analytic requirements;

simple optical fibres enabling one of the ends of the said at least one measuring cell to be connected to the light source of the spectrophotometer, and the other end to the spectrophotometer's detector, so as to have a remote measurement outside the spectrophotometer for optical paths of different lengths;

possibly, bifurcating optical fibres, which will replace the simple optical fibres if it is desired to use several optical paths at the same time;

possibly, a switch, which is useful when several measuring cells are used, to direct the light of the spectrophotometer to one measuring cell rather than another; in this case, the sample of solution is conveyed simultaneously into each of the measuring cells, and the switch enables light to pass into one of the measuring cells, and subsequently into another, and so forth, in order to implement independent acquisitions, and thus to extend the analysis dynamic range.

To improve detection, the length of the optical path must be increased, the effect of which is to reduce the detection limits. Instead of using the conventional spectrophotometric methods with the use of tanks with a 1 cm optical path, LWCC (Liquid Waveguide Capillary Cells) of variable length (which may be up to 5 m in length) and of small internal volume are thus used.

To validate the absorbance measurement obtained using the spectrophotometer a check must be made that the reduction is complete, i.e. that the solution injected into the measuring cell contains only uranium in its oxidation IV state. To implement this, the absence of uranium of valence VI is checked at 420 nm (the wavelength at which the absorbance of uranium of valence VI is the greatest).

It is also important to check that the solution injected into the measuring cell does indeed contain uranium of valence IV. To implement this, a check is made that the four characteristic peaks of uranium of valence IV are indeed present in the absorption spectrum, i.e. three characteristic peaks of low absorbance values at wavelengths 430, 485 and 548 nm, and a main peak of maximum absorbance value at 652 nm.

In addition, the times for transferring the solution between the compartment of the electrochemical cell and the measuring cell must be determined, knowing that the internal volume of the measuring cell (forming the optical path) must be filled without air bubbles. For greater stability it is preferable to stop the peristaltic pump, used to convey the solution into the measuring cell, during acquisition of the absorbance signal.

Instantaneous acquisition of the absorption spectrum is implemented with an appropriate software between 300 nm and 900 nm.

Calibration of the Spectrophotometer:

To determine the uranium concentration of the aqueous solution the absorbance of uranium (IV) is measured. However, in order for this measurement to be accurate it is also important to know the absorbance of the spectral background of the solution containing the uranium (IV). By subtracting this value of the absorbance of the spectral background from the value of the absorbance obtained at 652 nm the value of the net absorbance of the uranium IV is obtained which will be used to determine the uranium concentration of the solution to be analysed using Beer-Lambert law.

The absorbance of the spectral background varies according to the solution's investigation matrix. For example, in the case of solutions originating from Kazakhstan the absorbance of the spectral background is measured at 574 nm.

It is also important to undertake the calibration in a 1% sulphuric medium, since this is the acidic medium in which the samples for analysis are found (case of Kazakhstan).

1% diluted acid is firstly introduced into the optical path of the measuring cell, and an acquisition of the spectrophotometer is initiated in spectral mode, whilst blocking the light from the spectrophotometer's source, in order to determine the source's background noise (also called the dark current).

The mask used to block the light originating from the UV source is then removed and, still in spectral mode, the acquisition of the spectrum of the source is implemented in order to determine the reference spectrum of this source.

When these steps have been implemented the spectrophotometer is put into absorbance mode: the device is then ready to implement the acquisition of absorbance spectra.

Standard Measurements:

In order to know the concentration of a solution a calibration curve must be available which was produced under the same conditions as those for measurement of the solution, and in particular produced using a measuring cell of fixed optical path.

In our example embodiment measurements are made in a measuring cell having a 5 cm optical path on standard samples having respectively the following uranium concentrations in a sulphuric medium:

1000 mg/L (curve 1), 750 mg/L (curve 2), 500 mg/L (curve 3), 250 mg/L (curve 4), 100 mg/L (curve 5), 75 mg/L (curve 6), 50 mg/L (curve 7).

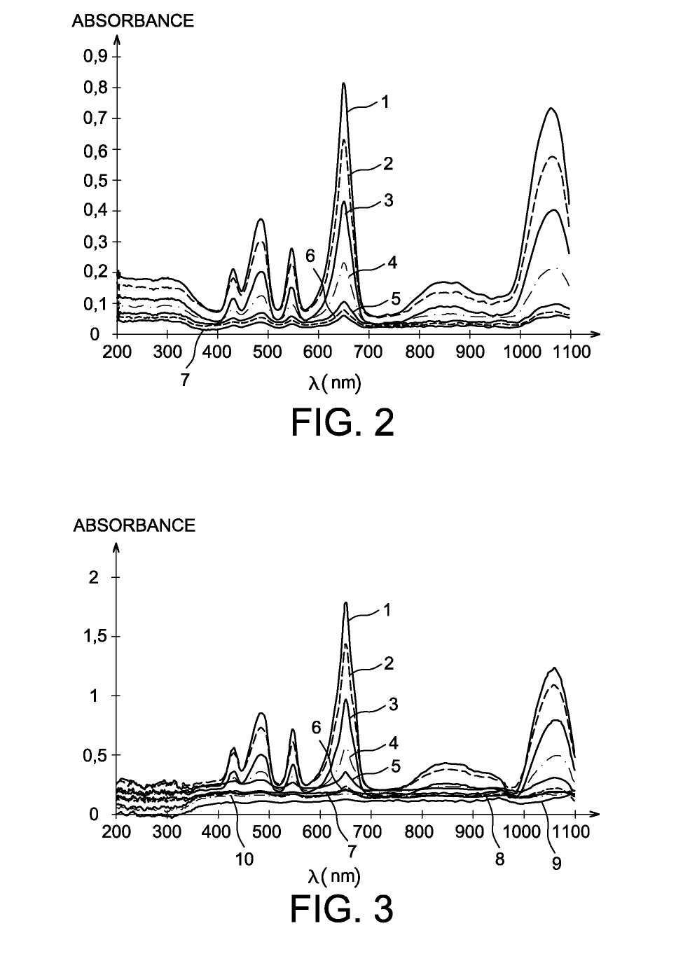

These absorption spectra as a function of wavelength are shown in the FIG. 2.

The same experiment was undertaken in a measuring cell having a 10 cm optical path with standard samples in a 1% sulphuric medium, including the following uranium concentrations:

1000 mg/L (curve 1), 750 mg/L (curve 2), 500 mg/L (curve 3), 250 mg/L (curve 4), 100 mg/L (curve 5), 75 mg/L (curve 6), 50 mg/L (curve 7), 30 mg/L (curve 8), 30 mg/L (curve 9), 20 mg/L (curve 10).

These absorption spectra are shown in FIG. 3.

For each of these standard solutions the solution is reduced, as described in the section “Reduction step”. It is stipulated that, bearing in mind the concentrations of the samples, and for a volume of 3.5 mL to be reduced, the oxidation-reduction reaction is undertaken over a period of 20 minutes, imposing a current of 1 Ampere between the electrodes.

When the uranium has been reduced to uranium (IV), the aliquot containing the reduced uranium is introduced into the optical path of the measuring cell and the spectrum is acquired.

The net absorbance value at 652 nm is calculated for each of the standard solutions.

From this absorbance data the calibration curve of the absorbance as a function of concentration is plotted, using an appropriate software, for example a software of the Excel® type.

As a criterion for acceptance of the measurements, the correlation coefficient must be close to 1, and the ordinate at the origin must be close to 0.

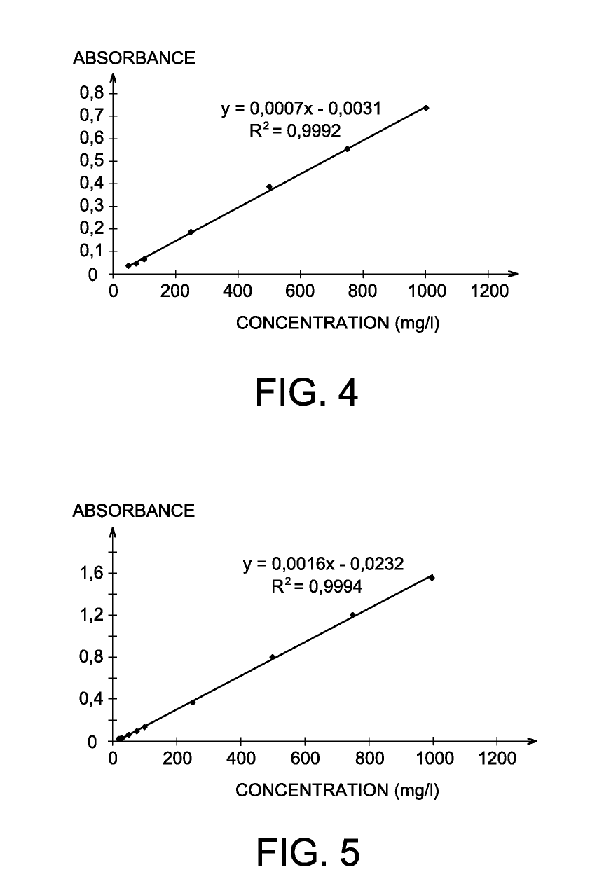

FIGS. 4 and 5 show the results of a calibration in a 1% sulphuric medium for 5 cm and 10 cm optical paths respectively.

It is stipulated that account was taken of the matrix of the samples in order that matrix effects might be disregarded. Indeed, a background at 574.46 nm was taken into account, with the samples originating from Kazakhstan.

It is observed that the values obtained are satisfactory. A linear response is indeed obtained for the 5 cm optical path (a straight line y=0.0007x-0.0031 and a correlation coefficient R² of 0.9992), and also for the 10 cm optical path (a straight line y=0.0016x-0.0232 and a correlation coefficient R² of 0.9994).

The standard curves obtained by this means can therefore be used.

It is observed that the lower limit of detection of the method according to the invention is 50 mg/L using a measuring cell having a 5 cm optical path (FIG. 4), but this limit is reduced to 20 mg/L when using a measuring cell having a 10 cm optical path (FIG. 5). This detection limit can therefore be lowered by choosing a measuring cell having a longer optical path, and can thus be lowered as far as 1 mg/L for an optical path of 200 cm.

Analysis of Samples of Unknown Uranium Concentration:

For each of the samples a reduction of the solution was firstly undertaken, followed by an acquisition of the spectrum, as explained above.

From the spectrum obtained, the net intensity of the absorbance at 652 nm is calculated, and this value is introduced in the calibration curve in order to determine the uranium concentration of this sample.

It is recalled that it is preferable to check before each analysis that the pH of the solution for analysis is less than 2 and, in the contrary case, to acidify it with a concentrated acid, preferably using the same acid as the one used to implement the calibration i.e., in our example embodiment, sulphuric acid.

In addition, the presence of several grams per litre of metal cations may interfere with the uranium (IV) absorbance measurement. It is therefore essential to check the appearance of the absorbance spectrum as a function of the wavelength in order to validate the measurement and, if applicable, to choose the spectral background to be subtracted.

The table below shows a semi-quantitative analysis of a leachate originating from Kazakhstan.

| | Concentration | | Concentration |
|---|---|---|---|
| Element | (mg/L) | Element | (mg/L) |
| Al | 10 << 50 | Rh | <0.1 |
| Ca | 50 << 500 | S | >500 |
| Ce | 10 << 50 | Si | 10 << 50 |
| Fe | 50 << 500 | Sr | 10 << 50 |
| K | 50 << 500 | U | 10 << 50 |
| The | 1 << 10 | V | 1 << 10 |
| Li | 1 << 10 | Y | 1 << 10 |
| Mg | 50 << 500 | Zn | 1 << 10 |
| Mn | 10 << 50 | Cl⁻ | 143 |
| Na | 50 << 500 | NO₃⁻ | 571 |
| P | 10 << 50 | PO₄³⁻ | <40 |
| Pr | 1 << 10 | SO₄²⁻ | 22900 |
| Rb | 1 << 10 | | |

This analysis shows that this solution has a salinity raised through the presence of iron, calcium, potassium, magnesium, sodium, sulphate, phosphate and nitrate.

Dosage of different solutions derived from leachates originating from a mining production site in Kazakhstan is undertaken using the method according to the invention with a measuring cell having a 5 cm optical path.

Samples 1 to 13 are samples taken on the site. The results obtained are shown in the table below.

| Reference of the | [U]_{measured} | | |
|---|---|---|---|
| sample | (mg/L) | [U]_{theoretical} (mg/L) | Difference |
| 1 | 134 | 150 | −10.7% |
| 2 | 381 | 406 | −6.2% |
| 3 | 191 | 210 | −8.9% |
| 4 | 340 | 306 | 11.0% |
| 5 | 536 | 515 | 4.0% |
| 6 | 600 | 642 | −6.5% |
| 7 | 588 | 629 | −6.6% |
| 8 | 356 | 310 | 14.7% |
| 9 | 385 | 346 | 11.2% |
| 10 | 645 | 619 | 4.2% |
| 11 | 49 | 51 | −4.8% |
| 12 | 134 | 150 | −10.7% |
| 13 | 625 | 780 | −19.9% |

We also used the method according to the invention to measure the uranium concentration of samples obtained by uranium doping according to the theoretical uranium contents of the matrix (sample 14), using a measuring cell having a 10 cm optical path.

The results obtained are shown in the table below:

| Reference of the | [U]_{measured} | [U]_{theoretical} | |
|---|---|---|---|
| sample | (mg/L) | (mg/L) | Difference |
| 14 | 27 | 20 | 36.0% |
| 15 | 315 | 370 | −14.7% |
| 16 | 107 | 120 | −10.6% |
| 17 | 233 | 270 | −13.8% |

These results show that the measuring method according to the invention is reliable: the difference between the measured concentration and the theoretical concentration is less than 20%, except for the samples having an uranium content close to the 20 mg/L detection limit.

Automation:

The steps of the measuring method according to the invention can be automated, and it is therefore possible to undertake inline analyses of the uranium concentration. To this end a sampler enables an aliquot of solution to be conveyed to the electrochemical cell and the spectrophotometer.

In FIG. 6 a possible example of integration of the steps of the method according to the invention is represented.

The solution to be dosed, for example a solution originating from a mining production well (not represented), is sampled and conveyed by a pump (not represented) into the two compartments 2, 3 of the electrochemical cell 1, electrodes 7, 6 of which are connected to a potentiostat 8.

When the reduction is terminated the solution contained in the compartment where an oxidation reaction occurred is removed to a collection container 9 by opening a valve; concerning the solution contained in the compartment where a reduction reaction occurred, it is drawn up by the pump 15 and conveyed simultaneously into two measuring cells 10 and 11, each cell having an optical path of different length, for example 10 cm and 200 cm. A switch (not represented) enables light from a lamp 12 to be passed into one of the optical paths, and then into the other. It is thus possible to implement the dosage of samples of low uranium concentration with the measuring cell having a long optical path, and the dosage of high concentrations with the other measuring cell.

A software and a computer 14 enable the data to be stored and the signal to be processed.

Rinsing (for example with a 1% diluted sulphuric acid) and oxidation of the compartments of electrochemical cell 1 are undertaken whilst the spectrophotometric measurement (measurement made by spectrophotometer 13) is being carried out.

Rinsing with acid (for example a 1% sulphuric acid) is undertaken in the measuring cells after the solution is removed into the collection container 9.

A correction of the background noise of the lamp and a trial run are undertaken before each analysis.

1. A method for measuring uranium concentration of an aqueous solution comprising:
a) providing an aqueous solution which contains uranium of a valence greater than valence IV;
b) implementing an electrochemical reduction towards valence IV, of the uranium of a valence greater than valence IV present in the aqueous solution, this reduction being implemented at pH<2 and bypassing an electrical current in the solution;
c) measuring the absorbance of the solution obtained on completion of step b) at a chosen wavelength comprised between 640 and 660 nm; and
d determining the uranium concentration of the aqueous solution by deduction of the uranium concentration of valence IV present in the aqueous solution obtained on completion of step b) from measurement of the absorbance obtained in step c).

2. The method according to claim 1, wherein step b) comprises the following operations:
distribution of the pH<2 solution in a first and second compartment of an electrochemical cell, where each compartment including an electrode intended to be in contact with the solution contained in this compartment, and the first and second compartments being separated from one another by a means allowing only electrons to pass from one compartment to the other;
application of an electrical current between the two electrodes to trigger an oxidation-reduction reaction, thereby the uranium of the fraction of solution contained in one of the compartments undergoes reduction, whereas the other fraction of solution contained in the other compartment undergoes oxidation.

3. The method according to claim 2, wherein the means allowing the passage of electrons is a sintered material.

4. The A method according to claim 1, wherein step b) comprises the following operations:
injection of all or part of the solution obtained on completion of step b) in at least one measuring cell, the interior of which forms an optical path greater than or equal to 5 centimetres between a first and a second end of the measuring cell;
transmission of a light beam of chosen wavelength through the at least one measuring cell, thereby the light beam enters by the first end and exits by the second end of the measuring cell;
detection of this light beam at its exit from the measuring cell by the second end.

5. The method according to claim 4, wherein the measuring cells are two in number, and have optical paths of differing lengths.

6. The method according to claim 1, wherein the chosen wavelength is the wavelength for which the absorbance of uranium of valence IV is the greatest.

7. The method according to claim 2, further comprising cleaning the first and second compartments of the electrochemical cell, by injection of a diluted acid in each of the compartments, and by application of a current between the electrodes, which is applied in an opposite direction to the current applied to implement the reduction of the uranium in step b).

8. The method according to claim 4, further comprising, after the detection of the light beam, cleaning the at least one measuring cell, by injection of an acid into the at least one measuring cell.

9. The method according to claim 1, wherein the aqueous solution is chosen from among solutions for production of uranium-bearing concentrates, effluents produced during treatment of an uranium-bearing ore, or effluents produced during treatment of an irradiated nuclear fuel.

10. A method for inline measurement of uranium concentration of an aqueous solution comprising:
i) sampling a volume of aqueous solution;
ii) measuring uranium concentration of this volume of aqueous solution by implementing the method of
a) providing an aqueous solution which contains uranium of a valence greater than valence IV;
b) implementing an electrochemical reduction towards valence IV, of the uranium of a valence greater than valence IV present in the aqueous solution, this reduction being implemented at pH<2 and bypassing an electrical current in the solution;
c) measuring the absorbance of the solution obtained on completion of step b) at a chosen wavelength comprised between 640 and 660 nm; and
d) determining the uranium concentration of the aqueous solution by deduction of the uranium concentration of valence IV present in the aqueous solution obtained on completion of step b) from measurement of the absorbance obtained in step c;
iii) repeating steps i) and ii) (n−1) times, thereby obtaining n measurements of the uranium concentration of the aqueous solution, where n is an integer greater than or equal to 2.
